(19) United States
(12) Patent Application Publication
(10) Pub. No.: US 2011/0212226 A1
(43) Pub. Date: Sep. 1, 2011

(54) Systems and Methods for Adhering Particles on Food Surfaces

(75) Inventors: David Soane, Chestnut Hill, MA (US); Michael C. Berg, Somerville, MA (US); Lauren Fortin, Stow, MA (US)

(73) Assignee: Durafizz, LLC

(21) Appl. No.: 13/038,419

(22) Filed: Mar. 2, 2011

Related U.S. Application Data
(63) Continuation of application No. PCT/US09/55588, filed on Sep. 1, 2009.
(60) Provisional application No. 61/093,507, filed on Sep. 2, 2008.

(51) Int. Cl. A23P 1/08; A23L 1/09; A23L 1/053

(52) U.S. Cl. 426/96; 426/293

(57) ABSTRACT

The invention relates to an improved food product comprising food substrate, a thin adhesive coating deposited on a surface of said food substrate and a particulate deposited on the thin adhesive coating wherein the adhesive coating comprises an edible polymer which, after dispersion in a solvent and deposition on the food substrate, causes adhesion of the particulate to the food substrate.

### RELATED APPLICATIONS

This application is a continuation of International Application No. PCT/US09/55588, which designated the United States and was filed on Sep. 1, 2009, published in English, which claims the benefit of U.S. Provisional Application. No. 61/093,507, filed Sep. 2, 2008. The entire teachings of the above applications are incorporated herein by reference.

### FIELD OF APPLICATION

This application relates generally to systems and methods for adhering particulate matter to the surfaces of food products.

### BACKGROUND

The capacity to adhere edible particulates onto cereal and other food surfaces is highly attractive for the food industry. Food products such as ready-to-eat cereals and snack foods frequently are flavored with edible food particulates. As examples, potato chips, tortilla chips, pretzels, crackers, popcorn, and numerous other foodstuffs often have seasonings applied to them during processing. Seasonings used, usually in a powdered form, have included salt, cheese, chili, garlic, Cajun spice, ranch, sour cream and onion, among many others. As another example, sugar coatings are commonly added to cereal flakes to produce the sweet taste that consumers desire; a sugar coating is advantageous because adding large amounts of sugar to the cereal composition itself can adversely affect other attributes of the cereal pieces. As another example, adhesion of edible particles is desirable for refrigerated/frozen, raw or precooked foods that are reconstituted through means of heating.

Adhering particulate matter to food products may involve using a food-grade adhesive. For example, oil may be used as an adhesive for attaching seasonings to certain foodstuffs. According to this technique, an extruded and cooked food product can be immersed in an oil and seasoning slurry at an elevated temperature. The product can then be dry-coated with seasonings, sprayed with seasonings, sprayed with heated or room temperature oils containing seasonings, or dusted with seasonings.

As another example, a coating agent formed from dry corn syrup solids or from mixtures of starch, maltodextrin and polysaccharides can be used to adhere small particles to a substrate. As an example, hot melt compositions made from starch (e.g., corn syrup, maltodextrin, or an amylase-treated starch) and a plasticizer like a polyol or a polyacetic acid can be used to adhere particulate additives such as sugar, salt, cheese powder and other seasonings to food products.

It is well-known, though, that particulate additives do not adhere completely and durably to food products. As an example, coatings that do not adhere well to the individual cereal pieces can flake off during manufacturing or transportation of the product, falling to the bottom of the packaged final product. Customers are used to seeing sugar and other coating flakes at the bottom of the cereal box, but this fine particulate matter can detract from their enjoyment of the product. In similar manner, for other snack products, flavor flakes or powders may settle to the bottom of the box. For products having a higher oil concentration, the flavor flakes or powders accumulate on the sides of the packaging as well. In each case, the consumer enjoys less of the desired ingredient on the product itself.

Moreover, the ingredients that fail to adhere to the cereal or snack product reduce the overall yield of the manufacturing process. To compensate for anticipated losses, the product developers or formulators can add additional flavoring ingredients during manufacturing based on what they expect will be lost. The additional flavoring ingredients must be accounted for on the labeling of the package, even if the majority of it detaches from the product and is never consumed. Furthermore, fallout of adherent flavors is especially undesirable when it occurs after manufacture, because expensive processing has already been applied to the food product and the loss of flavor impacts the consumer directly.

It would be advantageous, therefore, to improve the adherence of flavorings to food products. It would further be desirable to provide an adherence system adaptable to a number of flavorings and food product substrates. It may also be desirable in a food product to create a texture that enhances its mouth feel or other aesthetic properties, while achieving certain of the aforesaid advantages.

### SUMMARY

In embodiments, the invention relates to an improved food product comprising food substrate, a thin adhesive coating deposited on a surface of said food substrate and a particulate deposited on the thin adhesive coating wherein the adhesive coating comprises an edible polymer which, after dispersion in a solvent and deposition on the food substrate, causes adhesion of the particulate to the food substrate and, wherein said coating deposited on the food substrate has decreased tackiness after being subjected to drying or heating, or a combination thereof. The edible polymer is preferably a gum, such as gum arabic. The coating preferably further comprises a fructans and/or fructooligosaccharides, such as inulin, and/or a plasticizer, such as a sugar, glycerol, triacetin and combinations thereof. A preferred coating comprises (or consists essentially of) gum arabic, inulin and glycerin. One exemplary coating consists essentially of about 1 to about 50% by weight of edible polymer, about 1% to about 65% by weight fructan, about 1 to 80% by weight plasticizer and about 5 to about 95% by weight water, such as about 5 to about 40%% by weight of Gum Arabic, about 5 to about 40% by weight inulin and about 5 to about 40% by weight glycerin and 10 to 90% by weight of water. For example, the thin adhesive coating can be produced by combining water, the edible polymer and other coating components to form an aqueous solution, and boiling the solution to form a viscous syrup. The invention also relates to a process for manufacturing food products (and food products produced thereby) comprising food substrate, a thin adhesive coating deposited on a surface of said food substrate and a particulate deposited on the thin adhesive coating wherein the adhesive coating comprises an edible polymer which, after dispersion in a solvent and deposition on the food substrate, causes adhesion of the particulate to the food substrate and wherein said coating deposited on the food substrate shows decreased tackiness after being subjected to drying or heating, or a combination thereof, comprising the steps of: (a) combining water, the edible polymer and other optional coating components to form an aqueous solution and, optionally, boiling the solution to form a viscous syrup; (b) applying the product of step (a) to the food substrate, the particulate or both; and (c) depositing the particulate on the surface of the food substrate.

### BRIEF DESCRIPTION OF THE DRAWINGS

FIG. 1 is a plot of viscosity (cP) as a function of temperature (° F.) for the adhesive coating formulation of 40% Gum Arabic, 33.33% glycerin and 26.67% inulin, on a dry weight basis. The amount of water was adjusted for the desired % solids amount.

FIG. 2 is a plot of water activity as a function of % solids in the formulation of 40% gum arabic, 33.33% glycerin and 26.67% inulin, on a dry weight basis. The amount of water was adjusted for the desired % solids amount.

### DETAILED DESCRIPTION

Disclosed herein are systems and methods for adhering edible particulates to food surfaces. In embodiments, the systems and methods can involve applying tacky polymeric coatings to cereal or other food surfaces to adhere edible particulates thereto.

In embodiments, a polymeric coating according to these systems and methods can first be prepared, then applied to the food product by, for example, brushing, spraying or tumbling it onto the food surface or submersing the food into the coating mixture. In an embodiment, the coating may be pre-dried to a tacky-state, then tumbled with particulates, or immediately tumbled/coated with particulates after the coating has been applied to the food substrate. The food product, for example a cereal or a snack food, is then dried to the desired moisture content and water activity and/or heated. Other methods of application would be familiar to those having ordinary skill in the art.

As is known in the art, polymeric coatings and particle-on-surface technologies capable of binding particulates to food surfaces increase the adhesion between the particle and surface and therefore prolong the duration of their attachment to food surfaces while maintaining desired sensory characteristics of the product. Disclosed herein are systems and methods providing a broad-based particle-on-surface platform to permit the attachment of a wide variety of flavorings or other particulates to food products (e.g., sugar, sugar substitutes, salt, nuts, bread crumbs, dried particulates of fruits and/or vegetables (e.g. raisins, berries, shredded coconut, etc.), spices (e.g. cinnamon, nutmeg, mint, etc.), savories (e.g. thyme, garlic, onion, etc.), vitamins and minerals, powdered flavorings (e.g. dried cheese powder, fruit powders, vegetable powders, dried concentrated flavorings, etc.) or other particulate food additives (e.g., marshmallow bits, oats, caramel bits, chocolate bits, cocoa powder, coffee powder, tea powder, caffeine etc.). In accordance with these systems and methods, one or more water-soluble or water-insoluble particulate flavorings or additives can be attached to a substrate food product. In accordance with these systems and methods, various sized and shaped particles may be attached to a substrate food product. As examples, larger food particulates may also easily be attached to a substrate, including particulates such as: nuts (e.g. sliced/slivered almonds, chopped walnuts, etc), meat/fish (bacon pieces, roe, shrimp, chicken, and ground meat), dried fruit/vegetables (e.g. whole raisins, dried cranberries, sliced/shredded coconut, onion pieces, and citrus zest), crackers, pretzel pieces, crumbs (e.g., bread crumbs and tempura crumb) or other cereal pieces (e.g. rice puffs or extruded cereal pieces attached to flakes to create unique texture or oats attached to cereal surfaces). A range of particle sizes may be appropriate for attachment according to these systems and methods, depending on the shape of the material and its surface properties.

Polymers useful for attaching particles to food products can be soluble or dispersible in water or in organic solvents. Particles to be attached can be soluble or insoluble in the chosen solvent. As an example, sugar and salt crystals can be difficult to attach to food surfaces using a water soluble coating without dissolving the crystalline particulate into the aqueous phase of the wet adhesive. Using the methods disclosed herein, an aqueous adhesive coating can be partially dried to a state where the crystalline particulates will not dissolve, but will instead adhere to the food surface.

In addition, polymers used in these coatings can provide or act as protection from moisture. For example, some cereal products are known to become soggy quickly after being submerged in milk. In embodiments, a polymeric coating around the cereal surface may provide an extra protective moisture barrier to allow for less penetration of milk into the cereal core. Therefore, the cereal may remain crisp for a longer amount of time throughout the eating experience.

In embodiments, these systems and methods can be applied to flavoring cereal with a sugar coating. Currently, high fructose corn syrups and other sugar syrups are typically used to provide sugar coatings to cereal. The cereal can be coated with the sugar syrup, and then the sugar coating can be dried onto the cereal. In embodiments, the systems and methods disclosed herein can improve the drying time for imparting the sugary flavor to cereal and can thus improve production efficiency. In embodiments, a thin layer of polymeric material that exhibits tacky properties can be utilized to apply a crystalline sugar coating directly to cereal surfaces, so that it dries more quickly on the surface compared, for example, to a thick sugar syrup layer. Further, in embodiments, these methods can be used to affix granulated sugar crystals directly to the cereal surface, avoiding the use of high fructose corn syrup or other high-calorie adhesive agents. Desirably, these systems and methods can yield sugared cereals having less overall sugar, but with a taste profile with sweetness and texture that is similar to current products. In embodiments, new textures for cereal pieces can be created by using polymeric materials to attach other foods to the cereal, or to attach cereal pieces to each other.

In embodiments, micro- or nano-encapsulated liquid or powdered materials, such as flavors, can be adhered to cereal and food product surfaces to provide a burst of flavor, sensation and the like while being consumed. Micro- or nano-encapsulated materials can be water or oil based and encapsulated with a polymer that does not dissolve into the encapsulated material. The encapsulated material can be released upon mastication when eaten. In embodiments, flavors such as fruit flavors (strawberry, blueberry, raspberry, banana, apple, orange, etc.), honey, chocolate flavors, nut flavors, and the like, can be encapsulated and used to flavor cereal and food surfaces.

In embodiments, these systems and methods can be applied to nutrient fortification for cereal or snack products. In embodiments, soluble fiber (e.g. inulin, fructans, fructoolgiosaccharides) can be added to the coating in addition to other polymeric material to fortify cereal or food products with prebiotics. In embodiments, proteins can be included within coatings to increase the overall protein level within the cereal or food product. In embodiments, the nutrient fortification or health benefit can reside within the edible particulate such as incorporation of antioxidant rich powdered or particulated super fruits (e.g. acai, mangosteen, pomegranate, blueberries, cranberries, etc.) and vegetables (spinach, beets, tomatoes, etc).

This invention also relates to the adherence of texture-altering particulates onto food substrate surfaces.

In certain embodiments, an adhesive coating comprising one or more polymers and/or edible food components having adhesive properties can be used to attach particles to food surfaces. As an initial step, the selected polymer(s) and/or edible food components are allowed to disperse and/or dissolve in water or other solvent before to form a coating mixture. In embodiments, polymers or oligomers such as Gum Arabic, carboxymethyl cellulose (CMC), hydroxypropyl methyl cellulose (HPMC), carrageenan, pectin, xanthan gum, pullulan, alginates, soluble fiber (fructans, fructooligosaccharides, inulin), proteins (casein, egg albumen, wheat gluten, or whey), amino acids, starches, shellac, zein, polyvinyl alcohol, polyvinyl acetate, and the like, can be used for coating food products. The polymer or combination of polymers may be modified by small molecule plasticizers such as sugars, glycerol, and/or triacetin to modify the physical properties of the resulting polymer film. In many cases, natural plasticizers such as glycerol may be preferred.

Once fully dispersed and/or dissolved, the coating mixture can be applied to a pre-weighed amount of a food product substrate, using techniques familiar to those of ordinary skill in the art, for example, spraying, tumbling, brushing, pouring, immersing, and the like. In embodiments, the coating mixture is added to the food substrate after it is cooked, for example to a flake cereal after the drying/crisping step. In other embodiments, the coating mixture is added to the food substrate as part of the processing step, halfway through cooking for example. In embodiments, suitable food product substrates can include substances such as the surfaces of cereals, vegetable and potato chips, crackers, granola bars, pretzels, dried fruit, nuts, cookies and breads, and the like. The food product substrates may be formed as cereal puffs, cereal flakes, chips, formed products or any other suitable shape and size for the application of a particulate flavoring coating. In other embodiments, suitable food product substrates can include substances such as meats, fish, poultry, cheese, dairy (yogurt, ice cream, etc.), legume products (e.g., tofu), protein preparations, tempura prepared foods (e.g. meats, seafood and vegetable), bakery food products (pie crusts, breads, cookies, etc.) vegetables (potatoes, sweet potatoes, yams, onions, etc.), fruits and granola bars.

After the coated food product substrate has attained the requisite degree of tackiness, the selected particulate (e.g. flavoring(s) or textured materials (onions, nuts, coconut, dried or processed fruits, etc.)), can be added to the coated food product substrate by tumbling, inclusion dusting, sprinkling, and the like, with or without heat, depending upon on the mixture composition and properties. Particulates can be added and tumbled with the food product substrate either immediately after initial coating has been applied, or after tackiness has been induced through heat addition and water loss. The amount of particulate to be added can be determined using methodologies familiar to those of ordinary skill in the art, including evaluation of the amount of flavor provided by a given additive, the caloric content of the additive, the desired textural properties, and the like. When there has been adequate adherence of particulate flavoring to the coated food product substrate, heat may be added to dry the coated complex further to a predetermined water content and water activity. For example, this can be completed with a conveyer, tray, and/or convection drying system. Or, as another example, the coating mixture can be applied to the surfaces of the food product substrate with an enrober or sprayer on a conveyor system. As the coated food product substrate passes along the conveyor system, particulate flavoring can be applied at a separate station. The conveyor system can then transport the coated complex into a convection oven or other drying system.

In an embodiment, the particulate flavoring(s) can be dispersed into the coating mixture and then applied to the food surface using one of the means described above. In yet another embodiment, the coating mixture can be applied to the particles to coat them using a means such as spray drying, precipitation, dip coating, or spray-on. The coated particles can then be attached to the surfaces of the food product substrates while the coating material is still tacky.

As will be understood by the skilled artisan, the edible polymer, solvent and/or one or more other coating components can be used in an amount that permits adhesion of the particulate to the food substrate and optionally, that renders the tackiness of the coating to be decreased after drying, heating or a combination thereof. It is to be understood after drying, heating or both, the adhesive strength of the coating is decreased, however, the cohesive strength between the food substrate and particulate is substantially unchanged such that the food substrate and particulate to remain substantially cohesively attached. In one example, the adhesive coating can comprise the edible polymer in an amount between about 1 and about 50% by weight. In another example, the adhesive coating comprises edible polymer in an amount between about 5 and 40% by weight. In yet another example, the adhesive coating can comprise water in an amount from about 5 to about 95% by weight or about 10 to about 90% by weight. As discussed above, the adhesive coating can also comprise a plasticizer such as glycerin. In one example, the adhesive coating comprises glycerin in an amount from about 1 to about 50% or about 5 to about 40% by weight. The adhesive coating can also comprise a fructan such as inulin or other soluble fiber. In some examples, the adhesive coating comprises inulin or other soluble fiber in an amount from about 1 to about 65% by weight or about 5 to about 30% by weight.

In another example of the present invention, the adhesive coating comprises an edible polymer, water, glycerin and inulin, wherein the edible polymer is present in an amount from about 1 to about 50% by weight, water is present in an amount from about 5 to about 95% by weight, glycerin is present in an amount from about 1 to about 50% by weight and inulin or other soluble fiber is present in an amount from about 1 to about 65% by weight. In another example, the edible polymer is present in an amount from about 5 to about 40% by weight, water is present in an amount from about 5 to about 95% by weight, glycerin is present in an amount from about 5 to about 40% by weight and inulin or other soluble fiber is present in an amount from about 5 to about 30% by weight.

As described above, the adhesive coating can also be prepared by combining water, the edible polymer and other optional coating components to form an aqueous solution and boiling the solution to form a solution having a syrup-like viscosity, for example, the viscosity of the solution can be in the range of about 1,000 to 11,000 cPs. In an example of such an adhesive coating, the edible polymer is present in an amount from 10 to about 50% by weight and water is present in an amount from about 5 to about 75% by weight. The adhesive coating prepared by heating the solution to form a viscous syrup can additionally comprise glycerin in amount from about 10 to about 50% by weight and/or inulin or other soluble fiber in an amount from about 10 to about 65% by weight. In yet another example, the adhesive coating can comprise water in an amount from about 10 to about 55% by weight, edible polymer in an amount from about 15 to about 40% by weight, glycerin in an amount from about 15 to about 40% by weight and inulin or soluble fiber in an amount from about 10 to about 30% by weight.

The adhesive coating can also be prepared by combining water, the edible polymer and other optional coating components to form an aqueous solution wherein the solution is not heated before deposition on the food substrate. In one example, this adhesive coating can comprise the edible polymer in an amount from about 1 to about 30% and water in an amount from about 40 to about 95% by weight. Such an adhesive coating can further comprise glycerin in an amount from about 1 to about 30% and/or inulin or other soluble fiber in an amount from about 1 to about 30% by weight. In a further example, the adhesive coating can comprise the edible polymer in an amount from about 5 to about 15% by weight, water in an amount from about 50 to about 90%, glycerin from about 5 to about 15% and inulin or soluble fiber from about 5 to about 10% by weight.

### EXAMPLES

The following examples are provided to illustrate some aspects of the present application. The examples, however, are not meant to limit the practice of any embodiment of the invention. For example, the amounts of component ingredients in the formulation can be modified in order to achieve various advantageous properties.

Moreover, as would be understood by those of ordinary skill in the art, the processes described in the following examples can be scaled up onto production-size equipment. For cereal, the food product substrate can be fully processed (i.e. extruded, gun puffed, flaked between steel rollers, etc.) and then coated with a coating mixture. The coating mixture can be applied by adding appropriate steps to the current processing methodology. For example, puffed cereal (i.e., a puffed rice cereal) and flakes (i.e., a corn flakes cereal) can be coated within a rotating drum system, or on a conveyer system containing an enrober/sprayer, inclusion duster and some type of oven or heating system. A rotating drum may be particularly advantageous for applying the coating mixture, as it provides the option of applying heat during the application process to drive out excess water and aid in crisping the cereal product. If further heating and/or crisping is desired, the coated product can be conveyed into a convection chamber or an oven.

### Example 1

### Particulate Adherence Testing

Adherence testing as described in this Example was used to evaluate the effectiveness of a polymeric coating. About 5 grams of coated cereal were put into a food storage bag. The bag was vigorously shaken for 15 seconds, or 30 seconds for an “extended adherence test”. Cereal pieces were then removed from the food storage bag and weighed. The ratio (by weight) of particulates or food pieces that originally adhered versus those that did not adhere was used to calculate the percent adherence.

### Example 2

### Surface Coating with Gum Arabic

A 2.5 gram total mixture of water (88 wt %) and Gum Arabic (12 wt %) was blended together until the Gum Arabic was fully dispersed and hydrated. This coating mixture was used to coat puffed rice cereal samples weighing approximately 8 grams each, and corn flake cereal samples weighing approximately 10 grams each. Samples of each cereal were either spread out onto a sheet of aluminum foil and spray coated with the coating mixture, or tumbled coated within a sealed container with the coating mixture, until a thin layer coated the cereal. After the application of the coating mixture, the puffed rice cereal was then tumble coated with either 1.0 gram of granulated table sugar or 0.25 grams of ground cinnamon, to produce coated cereal complexes. After the application of the coating mixture, the corn flakes cereal was then tumble coated with either 2.0 grams of sugar, 0.7 grams of ground cinnamon, or 2.0 grams of drum dried fruit powder, to produce coated cereal complexes. All samples of the coated cereal complexes were placed in an 80° C. convection oven for approximately 15 minutes. Adherence test results (Example 1) showed that sugar had around 95% adherence and cinnamon exhibited 87% adherence.

### Example 3

### Surface Coating with Gum Arabic and Soluble Fiber

A 2.5 gram total mixture of water (80 wt %), Gum Arabic (12 wt %), and inulin (8 wt %) was blended together until full dispersion and hydration were complete. This coating mixture was used to coat samples of corn flakes cereal weighing approximately 10 grams each. The cereal samples were either spread out onto a sheet of aluminum foil and spray coated with the coating mixture, or tumbled coated within a sealed container with the coating mixture, until a thin layer coated the cereal. After application of the coating mixture, the corn flakes cereal were then coated with either 2.0 grams of granulated table sugar, 0.7 grams of ground cinnamon, or 2.0 grams of drum dried fruit powder, to produce coated cereal complexes. The coated cereal complexes were placed into an 80° C. convection oven for approximately 15 minutes. Adherence test results (Example 1) showed that sugar had around a 93% adherence and cinnamon exhibited around 90% adherence.

### Example 4

### Surface Coating with Gum Arabic, Soluble Fiber, and Sucrose

A 2.5 gram total mixture of water (57.1 wt %), Gum Arabic (8.6 wt %), inulin (5.7 wt %), and sucrose/table sugar (28.6 wt %) was blended together until full dispersion and hydration were completed. The coating mixture was used to coat samples of a corn flakes cereal weighing approximately 10 grams each. The cereal samples were either spread out onto a sheet of aluminum foil and spray coated with the coating mixture, or tumbled coated within a sealed container with the coating mixture, until a thin layer coated the cereal. After application of the coating mixture, the corn flakes cereal samples were then coated with either 2.0 grams of granulated table sugar, 0.7 grams of ground cinnamon, or 2.0 grams of drum-dried fruit powder. The coated cereal complexes were placed into an 80° C. convection oven for approximately 15 minutes. Adherence test results (Example 1) showed that sugar had around a 91% adherence and cinnamon exhibited 85% adherence.

### Example 5

### Surface Coating with a Syrup-Like Viscosity Containing Gum Arabic, Soluble Fiber, and Plasticizer

A mixture of water (70.6 wt %), Gum Arabic (10.6 wt %), inulin (7.1 wt %) and glycerin (11.7 wt %) was blended together until full dispersion and hydration were complete. The coating mixture was then heated to boiling until viscosity change was apparent and a syrup-like consistency was attained. The overall weight of the coating mixture was reduced by about 61.7 wt % as the syrupy state was attained, attributable to water loss. The water activity of the syrup-like mixture was measured with a water activity meter (AquaLab, Decagon Devices) and had a reading of 0.570. The mixture was then applied to 10 grams of corn flakes cereal by brush coating, to create a tacky coated cereal. Prior to coating with the particulate, the cereal with the coating mixture applied was heated in a convection oven at 80° C. for 8 minutes. Addition of approximately 2 grams of granulated sugar or 2 grams of drum dried fruit powder was then added to the tacky coated cereal to form a coated cereal complex. Cinnamon (0.7 grams) was combined with the syrup-like coating (1 gram) to produce a cinnamon paste. The paste was brush coated onto the cereal flakes. The coated cereal complexes were heated in an 80° C. oven for approximately 20 minutes. The water activity of the final coated, dried cereal flake products was 0.310. Both sugar and cinnamon cereal-complexes exhibited 100% adherence when subjected to the adherence test set forth in Example 1.

### Example 6

### Surface Coating with a Syrup-Like Viscosity Containing Soluble Fiber and Plasticizer

A mixture of water (64 wt %), inulin (25 wt %) and glycerin (11 wt %) were blended together until full dispersion was complete. The coating mixture was then heated to boiling until a viscosity change was apparent and a syrup-like tacky mixture was formed, about 59 wt % reduction. The experimental purpose was to see if soluble fiber in absence of Gum Arabic would form a similar tacky, syrup-like coating. It did form a syrup-like coating, however when more water was removed, the mixture became too viscous to mix. The coating was applied directly to 10 grams of corn flakes cereal in the amount of 2 grams and sugar crystals were sprinkled over the top (2 grams). The coating (2 grams) was also mixed directly in with cinnamon (0.7 grams). The complexed-coating syrup-like mixture was then brushed onto cereal pieces. The cereal complexes were put into a convection oven at 80° C. for 20 minutes. The cereal coating remained tacky even after extended heating of an additional 20 minutes (40 minutes total). Other coatings did not exhibit this property. The coating showed 100% adherence of sugar and cinnamon, most likely due to the tackiness of the coating. Also, some sugar crystals dissolved into the coating even after further heating.

### Example 7

### Surface Coating with Gum Arabic, Soluble Fiber, Plasticizer, and Water Insoluble Particulates

A mixture of water (70.58 wt %), Gum Arabic (10.58 wt %), inulin (7.05 wt %), and glycerin (11.76 wt %) were blended together until full dispersion and hydration were complete to produce a 2 gram mixture. Ground cinnamon or ground pepper (0.5 grams) was added to the mixture and combined until dispersed. The coating mixture was then applied to a 10 gram sample of corn flakes cereal by tumbling in a sealed container. The coated cereal was heated in an 80° C. for approximately 15 minutes. Adherence test results (Example 1) showed that ground pepper showed 100% adherence and cinnamon showed 96% adherence. Another test was completed where the coating was sprayed onto the cereal and particulates were sprinkled onto the cereal surfaces. The adherence tests for those samples showed that ground pepper showed 87% adherence and cinnamon exhibited 90% adherence. Directly combining insoluble particulates into the coating mixture increased the adherence of those particulates on cereal surfaces.

### Example 8

### Shredded, Unsweetened Coconut Adhered onto Cereal with Use of Gum Arabic, Soluble Fiber, and Plasticizer

A mixture of water (70.58 wt %), Gum Arabic (10.58 wt %), inulin (7.05 wt %), and glycerin (11.76 wt %) were blended together until full dispersion and hydration were complete to produce a 1.1 gram mixture. Shredded, unsweetened coconut (1.1 grams) was put directly into the coating mixture. Wet-coated coconut was put directly onto corn flakes cereal pieces (3 large flakes) and heated in an 80° C. oven for approximately 20 minutes. Coconut adhered very well to cereal pieces, showing 100% adherence during the extended adherence test (Example 1). When the sample was submerged into water, the coconut remained adherent and did not separate from the cereal surface as would be expected in the absence of such adherence.

### Example 9

### Sliced Dry Almonds Adhered onto Cereal with Use of Gum Arabic, Soluble Fiber, and Plasticizer

A mixture of water (70.58 wt %), Gum Arabic (10.58 wt %), inulin (7.05 wt %), and glycerin (11.76 wt %) were blended together until full dispersion and hydration were complete to produce a 0.35 gram mixture. Sliced, dry almonds (0.83 grams) were put directly into the coating mixture. Wet-coated almond slices were directly put onto corn flakes cereal pieces (3 large flakes) and heated in an 80° C. oven for approximately 20 minutes. Almonds adhered very well to cereal pieces and showed 100% adherence during the extended adherence test (Example 1).

### Example 10

### Whole Raisins Adhered onto Cereal with Use of Gum Arabic, Soluble Fiber, and Plasticizer

A mixture of water (70.58 wt %), Gum Arabic (10.58 wt %), inulin (7.05 wt %), and glycerin (11.76 wt %) were blended together until full dispersion and hydration were complete to produce a 0.55 gram mixture. Three whole raisins (1.4 grams) were put directly into the coating mixture. Wet-coated raisins were directly put onto corn flakes pieces (3 large flakes) and heated in an 80° C. oven for approximately 20 minutes. Raisins adhered very well to cereal pieces and showed 100% adherence during the extended adherence test (Example 1).

### Example 11

### Puffed Rice Cereal Adhered onto Corn Flakes with Use of Gum Arabic, Soluble Fiber, and Plasticizer Syrup Coating

A mixture of water (70.58 wt %), Gum Arabic (10.58 wt %), inulin (7.05 wt %), and glycerin (11.76 wt %) were blended together until full dispersion and hydration were complete to produce an 8.5 gram mixture. The mixture was heated until 5.25 grams of weight was lost, attributable to water loss. The mixture exhibited a viscosity change and a syrup-like consistency was attained. A puffed rice cereal was coated on one side with the syrup-like mixture and adhered upon the surface of corn flakes cereal. For 0.28 grams of puffed rice cereal used, 0.24 grams of syrup coating was used. Corn flake-puffed rice cereal complexes were heated in an 80° C. oven for approximately 20 minutes. Puffed rice cereal adhered very well to corn flakes cereal and showed 100% adherence during the adherence test (Example 1).

### Example 12

### Shredded, Unsweetened Coconut Adhered onto Cereal with Use of Gum Arabic, Soluble Fiber, and Plasticizer Syrup Coating

A mixture of water (70.58 wt %), Gum Arabic (10.58 wt %), inulin (7.05 wt %), and glycerin (11.76 wt %) were blended together until full dispersion and hydration were complete to produce an 8.5 gram mixture. The mixture was heated until 5.25 grams of weight was lost, attributable to water loss. The mixture showed a viscosity change and a syrup-like consistency was attained. Shredded coconut (0.4 grams) had one side brushed with the coating mixture (0.22 grams) then adhered to corn flakes cereal. Corn flake-coconut cereal complexes were heated in an 80° C. oven for approximately 20 minutes. Shredded coconut adhered very well to the corn flakes cereal and showed 100% adherence during the adherence test (Example 1).

### Example 13

### Bowl Life Testing on Coated Cereal Complexes

Coating formulation from Example 7 was used to determine if cereal complexes would provide moisture barrier properties to cereal surfaces. The coating was either mixed with cinnamon prior to coating on cereal, or it was coated onto cereal then sugar crystals were added to the surface. Coated corn flakes cereal (5 grams) was submerged in 18.27 grams of water for 1 minute and 30 seconds. The water was then drained and the cereal was weighed for water uptake to determine if the bowl life of the cereal is improved from a control of uncoated corn flakes. Corn flakes cereal (uncoated) took up 2.2 times its weight in water during the test. Frosted flakes cereal took up 1.5 times its weight in water during the test. The corn flakes sample with cinnamon within the coating took up 1.9 times its weight in water during the test. Further, the corn flakes sample that was coated then had sugar crystals added took up 1.5 times its weight in water during the test. At least half of the cinnamon on the cinnamon coated sample remained adhered on the flakes when put into water. The other half was dispersed throughout the water phase. We conclude that the coating provides a moisture barrier to the cereal core as compared to uncoated cereal flakes.

### Example 14

### Microencapsulated Carbon Dioxide Powder Adhered onto Corn Flakes with Use of Gum Arabic, Inulin and Plasticizer Syrup Coating

A mixture of water (70.58 wt %), Gum Arabic (10.58 wt %), inulin (7.05 wt %), and glycerin (11.76 wt %) were blended together until full dispersion and hydration were complete to produce an 8.5 gram mixture. The mixture was heated until 5.25 grams of weight was lost, attributable to water loss. Microencapsulated carbon dioxide (prepared according to the methods disclosed in U.S. patent application US2005/0287276, the contents of which are incorporated by reference herein) was produced by combining sodium bicarbonate (7 grams), 25 wt % shellac solution in isopropyl alcohol (1.25 grams), acetone (12.5 mL), isopropyl alcohol (25 mL), and maltodextrin M100 (4 grams). The mixture was sprayed with a paint sprayer (could also be spray dried) until an encapsulated powder was formed. Corn flakes cereal was brush coated with the coating mixture and the microencapsulated carbon dioxide powder with added citric acid particulates (0.1 g added to the carbon dioxide powder) was dusted onto the coating until the cereal coating was fully dusted. The cereal was submerged in water to test if light carbonation was detectable. Several small bubbles were observed and the coated cereal provided light carbonation to the water phase.

### Example 15

### Surface Coating Mixture Preparation with Gum Arabic, Soluble Fiber and Plasticizer

A 40 pound batch of surface coating mixture was prepared on pilot scale equipment as described below. A jacketed high-speed mixer used to prepare the mixture for this Example. The ingredient amounts set forth in Table 1 were used for this Example. First, one half of the amount of glycerin (˜11.33 wt %) and all of the water were added into the mixer. The mixer was set to mix at 19 RPM. The remaining ingredients (gum arabic, inulin) were added in the amounts described in Table 1 along with the remaining glycerin and the mixer speed was turned up to 27 RPM. The material was heated and kept at a temperature between 165-175° F. The material mixed until homogeneous and the percent solids reached around 68%-75% with a water activity around 0.8. This surface coating adhesive mixture was passed through a sieve before use.

TABLE 1

| | AMOUNT |
|---|---|
| INGREDIENT | Weight % |
| Gum Arabic | 27.2 |
| Inulin | 18.125 |
| Glycerin (99.7% USP) | 22.675 |
| Water | 32 |

### Example 16

### Surface Coating Mixture Viscosity as a Function of Temperature

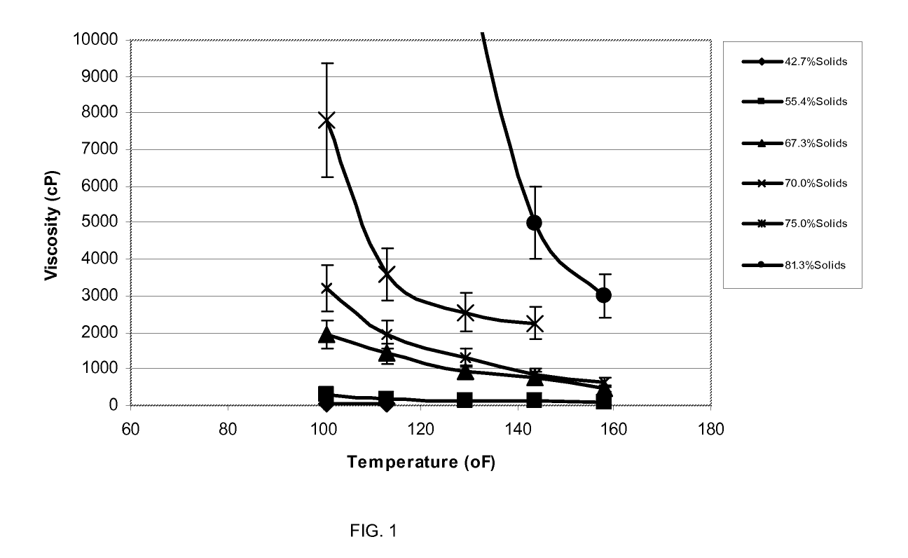

The formulation from Example 15 was tested for viscosity. The amount of water was varied to provide a variation of percent solids material. Once the surface coating material was at the desired percent solids, it was heated to the desired temperature and tested. A Brookfield Viscometer (Model LVDV-III) was used to measure viscosity of the various samples. FIG. 1 shows the relationship between viscosity and temperature for these samples.

### Example 17

### Surface Coating Mixture Water Activity as a Function of Total Percent Solids

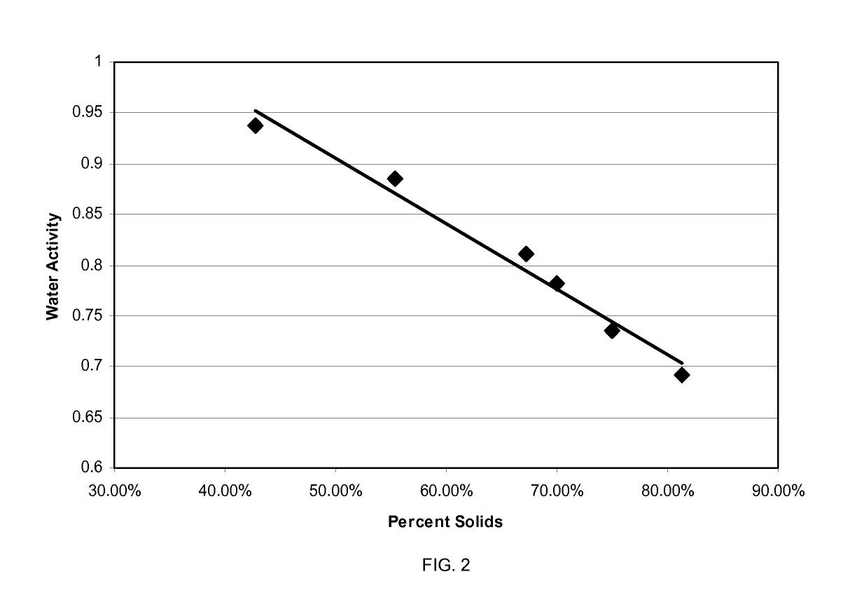

The formulation from Example 15 was used to test water activity. The amount of water was varied in the base formula to provide a variation of percent solids material. Once the surface coating material was at the desired percent solids, it was tested for water activity level. A Decagon Devices, Inc. Aqua Lab (model Series 3TE) was used to measure water activity. Results for water activity of these samples are set forth in FIG. 2.

### Example 18

### Use of Surface Coating Mixture onto Cereal Pieces

The surface coating mixture from Example 15 was passed through a hopper and into a spray system. A standard mixture of cereal pieces was coated with a sugar solution and then sprayed with the material from Example 15. The feed rate of the sprayer delivered between 50-80 grams/minute of the surface coating mixture to the substrate cereal pieces. The cereal pieces were allowed to dry and were tested for adherence of sugar and were examined for flavor and texture. No off-flavors were noted, and no aberrant textures were observed.

### Example 19

### Sugar Adherence Testing on Cereal

A shake test was completed with a sieve shaker, using cereal coated in accordance with Example 18. Controls were simultaneously run and prepared in the same manner as Example 18's cereal without the addition of surface coating mixture. Coated cereal pieces were put through the shake test and fines were collected. The collected material was weighed and compared with control samples. Up to 50% reduced fines were noted with the addition of the surface coating mixture.

While this invention has been particularly shown and described with references to preferred embodiments thereof, it will be understood by those skilled in the art that various changes in form and details may be made therein without departing from the scope of the invention encompassed by the appended claims.

1. A food product comprising a food substrate, a thin adhesive coating deposited on a surface of said food substrate and a particulate deposited on the thin adhesive coating, wherein the adhesive coating comprises an edible polymer which, after dispersion in a solvent and deposition on the food substrate, causes adhesion of the particulate to the food substrate and wherein said coating deposited on the food substrate has decreased tackiness after being subjected to drying or heating, or a combination thereof.

2. The product of claim 1, wherein the solvent is water.

3. The product of claim 1, wherein the coating comprises an edible polymer, a fructan and a plasticizer.

4. The product of claim 1, wherein the edible polymer is a gum.

5. The product of claim 4, wherein the gum is Gum Arabic.

6. The product of claim 1, wherein the thin adhesive coating further comprises a fructan.

7. The product of claim 6, wherein the fructan is inulin.

8. The product of claim 1, wherein the thin adhesive coating further comprises a plasticizer.

9. The product of claim 8, wherein the plasticizer is selected from the group consisting of a sugar, glycerol, triacetin and a combination thereof.

10. The product of claim 1, wherein the thin adhesive coating comprises Gum Arabic, inulin and glycerin.

11. The product of claim 1, wherein the thin adhesive coating consists essentially of Gum Arabic, inulin, glycerin and water.

12. The product of claim 1, wherein the thin adhesive coating consists essentially of about 1 to about 50% by weight of edible polymer, about 1% to about 65% by weight fructan, about 1 to about 50% by weight plasticizer and about 5 to about 90% by weight water.

13. The product of claim 1, wherein the thin adhesive coating consists essentially of about 1 to about 50% by weight of Gum Arabic, about 1% to about 65% by weight inulin, about 1 to about 50% by weight glycerin and about 5 to about 90% by weight water.

14. The product of claim 1, wherein the thin adhesive coating consists essentially of about 5 to about 40% edible polymer, about 10 to about 90% water, about 5 to about 40% glycerin and about 5 to about 30% inulin.

15. The product of claim 1, wherein the thin adhesive coating consists essentially of about 36% by weight of Gum Arabic, 24% by weight inulin, 40% by weight glycerin and 32% by weight water.

16. The product of claim 1, wherein the thin adhesive coating is produced by combining water, the edible polymer and other coating components to form an aqueous solution, and boiling the solution to form a viscous syrup.

17. The product of claim 1, wherein the thin adhesive coating is produced by combining water, the edible polymer and other coating components to form an aqueous solution followed by combining said aqueous solution with said particulate.

18. A process for manufacturing food product comprising food substrate, a thin adhesive coating deposited on a surface of said food substrate and a particulate deposited on the thin adhesive coating wherein the adhesive coating comprises an edible polymer which, after dispersion in a solvent and deposition on the food substrate, causes adhesion of the particulate to the food substrate and, wherein said coating deposited on the food substrate has decreased tackiness after being subjected to drying or heating, or a combination thereof, comprising the steps of:
(a) combining water, the edible polymer and other coating components to form an aqueous solution and, optionally, boiling the solution to form a viscous syrup;
(b) applying the product of step (a) to the food substrate, the particulate or both; and
(c) depositing the particulate on the surface of the food substrate.

19. A food product produced by the process of claim 18.

20. The process of claim 18, wherein the aqueous solution is boiled to form a viscous syrup.

21. The process of claim 20, wherein the adhesive coating is applied to the food substrate followed by applying the particulate to the adhesive coating.

22. The process of claim 18, wherein the particulate is a water-soluble particulate.

23. The process of claim 22, wherein the particulate is sugar.

24. The process of claim 18, wherein the adhesive coating is not boiled before application to the food substrate or particulate.

25. The process of claim 24, wherein the adhesive coating is applied to the particulate before application to the food substrate.
